(19) United States
(12) Patent Application Publication
(10) Pub. No.: US 2022/0259848 A1
(43) Pub. Date: Aug. 18, 2022

(54) FASTENING DEVICE

(71) Applicant: Hilti Aktiengesellschaft, Schaan (LI)

(72) Inventors: Achim RUF, Feldkirch (AT); Uwe POPP, Widnau (CH); Christoph STUERTZEL, Sigmarszell (DE)

(21) Appl. No.: 17/623,043

(22) PCT Filed: Aug. 19, 2020
(86) PCT No.: PCT/EP2020/073144

§ 371 Date: Dec. 27, 2021

(30) Foreign Application Priority Data
Aug. 29, 2019 (EP) 19194421.4

(51) Int. Cl. E04B 1/76; F16B 13/04

(52) U.S. Cl. CPC E04B 1/7629; F16B 13/045

(57) ABSTRACT

A device for fastening a first object to a second object in a fastening direction is provided, the device comprising an anchoring element, a tension element and a prestressing element, wherein the anchoring element is provided to be anchored in a fastening direction in the second object, wherein the tension element is provided to transmit a tensile force from the anchoring element to the prestressing element to prestress the prestressing element in the fastening direction against the first object, and wherein the tension element comprises a composite of a plurality of fibers.

### BACKGROUND OF THE INVENTION

The present invention relates to a device for fastening a first object to a second object in a fastening direction.

Devices of this type frequently comprise an anchoring element which is anchored in the second object and a tension element which transmits a tensile force from the anchoring element to a prestressing element. Devices are known in which the tension element is formed by a rigid shaft which is molded onto the prestressing element.

### BRIEF SUMMARY OF THE INVENTION

The invention is based on the object of providing a device of the type in question with which fastening a first object to a second object is facilitated and/or improved.

The object is achieved in a device of the type in question which comprises an anchoring element, a tension element and a prestressing element, wherein the anchoring element is provided to be anchored in a fastening direction in the second object, wherein the tension element is provided to transmit a tensile force from the anchoring element to the prestressing element in order to prestress the prestressing element in the fastening direction against the first object, and wherein the tension element comprises a composite of a plurality of fibers.

An advantageous embodiment is characterized in that the tension element is flexible. The fibers are preferably movable relative to one another.

An advantageous embodiment is characterized in that the fibers each have a fiber longitudinal direction which is oriented substantially in the direction of the tensile force. The fibers preferably each extend from the anchoring element to the prestressing element. The fibers likewise preferably each have a fiber length which is smaller than a distance between the anchoring element and the prestressing element.

An advantageous embodiment is characterized in that the tension element is fastened to the anchoring element and/or to the prestressing element. The tension element is preferably knotted, spliced, sewn, clamped, welded, brazed and/or adhesively bonded to the anchoring element and/or to the prestressing element.

An advantageous embodiment is characterized in that the anchoring element and/or the prestressing element has a head and a neck to which the tension element is fastened.

An advantageous embodiment is characterized in that the anchoring element and/or the prestressing element has an eyelet to which the tension element is fastened.

An advantageous embodiment is characterized in that the fibers are connected to form a rope, a band or to form a tube.

An advantageous embodiment is characterized in that the fibers are twisted together, braided or interwoven.

An advantageous embodiment is characterized in that the fibers comprise natural fibers. The fibers preferably comprise natural fibers made from cotton, flax, hemp, coconut, manila, sisal and/or spider silk.

An advantageous embodiment is characterized in that the fibers comprise synthetic fibers. The fibers preferably comprise synthetic fibers made of carbon, aramid, polyester, polyamide, polypropylene, polyethylene and/or poly(p-phenylene-2,6-benzobisoxazole) (Zylon) [2].

An advantageous embodiment is characterized in that the fibers comprise metal fibers. The fibers preferably comprise metal fibers made of iron, steel and/or aluminum.

### BRIEF DESCRIPTION OF THE SEVERAL VIEWS OF THE DRAWINGS

The invention will be explained in more detail below with reference to the drawings. In the drawings:

FIG. 1 shows a fastening device in a side view,

FIG. 2 shows a fastening device in a side view,

FIG. 3 shows a fastening device in a side view,

FIG. 4 shows a fastening device during a fastening operation,

FIG. 5 shows a fastening device during a fastening operation,

FIG. 6 shows a fastening device during a fastening operation,

FIG. 7 shows a fastening device in a side view,

FIG. 8 shows a fastening device in a side view,

FIG. 9 shows a fastening device in a side view,

FIG. 10 shows a fastening device in a side view,

FIG. 11 shows a fastening device in a side view, and

FIG. 12 shows a fastening device in a side view.

### DETAILED DESCRIPTION OF THE INVENTION

FIG. 1 shows a first object 9 designed as an insulating element, a second object 20 designed as a building cover, for example as a roof or wall element made of concrete, masonry, wood or metal, or as a frame element made of concrete, wood or metal, in particular as a steel girder, and a fastening device 30 which is provided for fastening the first object 9 to the second object 20. The fastening device 30 comprises an anchoring element which, in a first exemplary embodiment shown in FIG. 1, comprises a screw 40 which is anchored in a hole previously produced in the second object 20, for example by means of a drilling tool, by screwing into a fastening device 45. Furthermore, the fastening device 30 comprises a plate-like prestressing element 50 which is prestressed in the fastening direction 45 against the first object 9 in order to press the first object 9 in the fastening direction 45 against the second object 20 and to hold said first object on the second object 20. Furthermore, the fastening device 30 comprises a tension element 60 which is connected to the screw 40 in a force-transmitting manner and to the prestressing element 50. As a result, the tension element 60 transmits a tensile force from the screw 40 to the prestressing element 50 in order to prestress the prestressing element 50 in the fastening direction 45 against the first object 9.

The tension element 60 comprises or consists of a composite of a plurality of fibers. In order to make the tension element 60 flexible, the fibers are movable relative to one another. The fibers each have a fiber longitudinal direction which is oriented substantially in the direction of the fastening direction 45 and therefore in the direction of the tensile force transmitted by the tension element 60. The fibers each extend continuously from the screw 40 as far as the prestressing element 50. In some exemplary embodiments, the fibers each have a fiber length which is smaller than a distance between the screw 40 and the prestressing element 50. The fibers are preferably connected, for example twisted together, braided or interwoven, to form a rope, a band or to form a tube. The fibers comprise natural fibers, synthetic fibers and/or metal fibers. The natural fibers consist for example of cotton, flax, hemp, coconut, manila, sisal and/or spider silk. The synthetic fibers consist, for example, of carbon, aramid, polyester, polyamide, polypropylene, polyethylene and/or poly(p-phenylene-2,6-benzobisoxazole) (Zylon) [2]. The metal fibers consist, for example, of iron, steel and/or aluminum.

The tension element 60 is preferably fastened to the screw 40 and to the prestressing element 50. For example, the tension element 60 is knotted, spliced, sewn, clamped, welded, brazed and/or adhesively bonded to the screw 40 and/or to the prestressing element 50. In the present exemplary embodiment, the anchoring element comprises a connecting element 41 which is held on a neck of the screw 40 and which has an eyelet to which the tension element 60 is fastened.

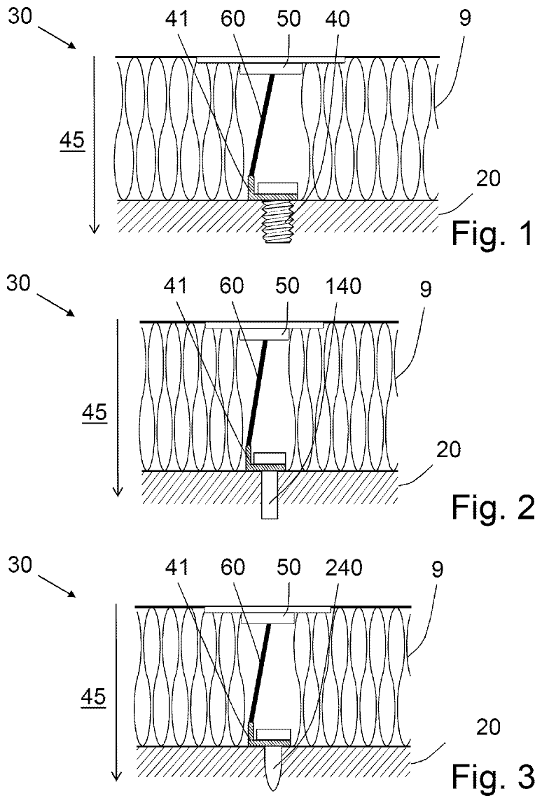

FIG. 2 likewise shows a first object 9, a second object 20 and a fastening device 30 with an anchoring element, a prestressing element 50 and a tension element 60. The anchoring element is comprises a dowel 140, which is anchored in a hole previously produced in the second object 20, for example by means of a drilling tool, by screwing, clamping and/or expanding in a fastening device 45. The other elements preferably correspond to the corresponding elements of the exemplary embodiment shown in FIG. 1.

FIG. 3 likewise shows a first object 9, a second object 20 and a fastening device 30 with an anchoring element, a prestressing element 50 and a tension element 60. The anchoring element is comprises a nail 240 which is driven into the second object 20 in a fastening device 45, in particular without pre-drilling, and is thus anchored. The other elements preferably correspond to the corresponding elements of the exemplary embodiment shown in FIG. 1.

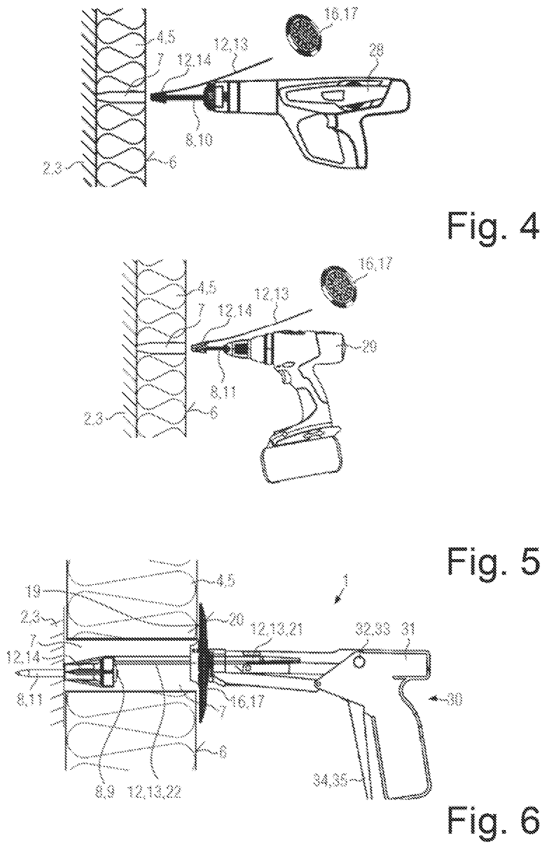

FIGS. 4 to 6 show a system 1 for fastening a layered component 4, namely insulation 5, to a wall 3 of a building as setting object 2. The system 1 comprises an anchoring element 8, a tension element 12, a prestressing element 16 and a pull-out tester 30. The anchoring element 8 and the tension element 12 are designed as separate components. The anchoring element 8 is formed by a screw 10 or a bolt 11 or nail 11, and a holding head 9 is formed at the end of the screw 10 or the bolt 11. The anchoring element 8 is formed from metal. The tension element 12 made of plastic comprises a fiber composite 13 and a coupling component 14 likewise made of plastic. A holding bore 15 is formed on the coupling component 14, the diameter of which holding bore is smaller than the diameter of the holding head 9, and therefore a shaft of the anchoring element 8 can thereby be passed through the holding bore 15 until the holding head 9 rests on the coupling component 14. The prestressing element 16 is designed as a plate-like or disk-shaped supporting part 17 made of plastic (FIGS. 3 and 4) with an opening 18 for the passage of the fiber composite 13 of the tension element 12. The prestressing element 16 has a first side 19 for placing on an outer side 6 of the layered component 4 and a second side 20. The second side 20 is formed opposite the first side 19. A plurality of teeth 24 or grooves 25 are formed as form-fitting elements 23 on the band 13, and a movable latching lug 27 as a mating form-fitting element 26 is present on the prestressing element 16. The tension element 12 has a first upper end according to the illustration in FIG. 3, and said first upper end can be passed through the opening 18 on the prestressing element 16. The second end of the tension element 12 is formed by the coupling component 14. Owing to the form-fitting elements 23 on the fiber composite 13 and to the mating form-fitting element 26 in the region of the opening 18 of the prestressing element 16, the band can be passed through the opening 18 only in one direction from the first side 19 to the second side 20 of the prestressing element 16. The first end of the tension element 12 is first pushed through the opening 18 on the first side 19 such that the fiber composite 13 thereby protrudes from the prestressing element 16 on the second side 20. To fasten the insulation 5 to the wall 3 of the building, not illustrated, the insulation 5 is first of all placed onto the wall 3 and then a through hole 7 is machined into the insulation 5 with a drill, not illustrated.

In the exemplary embodiment illustrated in FIG. 4, the tension element 12 with the anchoring element 8 fastened to the coupling component 14 as the screw 10 is passed through the through hole 7 until the screw 10 rests on the wall 3. The screw 10 is then screwed into the wall 3 (not illustrated) with a cordless screwdriver 28 (FIG. 4) and the screw 10 is thereby fastened to the wall 3. Owing to the holding head 9 of the screw 10 resting on the coupling component 14, the coupling component 14 and thus also the tension element 12 are fastened to the wall 3. Subsequently, the fiber composite 13, which protrudes from the through hole 7, is pushed through the prestressing element 16 by the first end of the fiber composite 13 being inserted through the opening 18 on the first side 19 of the prestressing element 16 until the first side 19 of the prestressing element 16 rests on the outer side 6 of the insulation 5 (FIG. 6).

The pull-out tester 30 has a housing 31 and an adjustment member 32 in the form of a rotary knob 33. Furthermore, the pull-out tester 30 comprises an actuating lever 35 as actuating member 34. Furthermore, an insertion opening for inserting the first end of the fiber composite 13 into the pull-out tester 30 and a removal opening for removing the fiber composite 13 from the pull-out tester 30 (not illustrated) are formed on the pull-out tester 30. That part 21 of the fiber composite 13 which protrudes from the opening 18 as the tension element 12 is inserted into the insertion opening of the pull-out tester 30 and a force is subsequently applied manually by hand to the actuating lever 35. In the pull-out tester 30 there are at least two movable gripping arms, not illustrated, which grip the part 21 of the fiber composite 13 within the pull-out tester 30 and, owing to the force applied to the actuating lever 35, apply a tensile force to the fiber composite 13 such that the front end of the pull-out tester 30 in the region of the insertion opening applies a compressive force to the second side 20 of the prestressing element 16. As a result, a different part 22 of the tension element 12 than the band 13 within the through hole 7 is subjected to a test tensile force, and said test tensile force is transmitted from the holding head 9, which rests on the coupling component 14, to the anchoring element 8 within the wall 3. As a result, the test tensile force is also applied to the screw 10 and the latter is tested. Further actuation of the actuating lever 35 increases the test tensile force up to a safety test tensile force. After the safety test tensile force has been exceeded, and therefore the test tensile force is greater than the safety test tensile force, a cutting mechanism, not illustrated, within the pull-out tester 30 is automatically activated by further actuation of the actuating lever 35 such that the part 21 of the tensile element 12 as the fiber composite 13 is automatically cut off within the pull-out tester 30 in the vicinity of the insertion opening.

FIG. 6 illustrates a second exemplary embodiment of the system 1. The anchoring element 8 is formed by the bolt 11 or the nail 11 and the bolt 11 is fastened with a setting tool 29 in the wall 3 as the setting object 2. Setting tools 29 (FIG. 6) are used to drive anchoring elements 8 as bolts 11 or nails 11 into a setting object 2 or substrate 2, for example, a wall 3 made of reinforced concrete or brick, and thus to fasten same. For this purpose, the setting tool 29 has a housing made of metal and/or plastic. In this case, a setting mechanism, which is operated electrically, pyrotechnically, pneumatically or by burning gas in a combustion chamber, is arranged within a tool body enclosed by the housing. A magazine for anchoring elements 8 is enclosed by another part of the housing. The magazine comprises a large number of anchoring elements 8. The first exemplary embodiment illustrated in FIG. 4 thus differs from the second exemplary embodiment illustrated in FIG. 5 in particular in that the setting tool 29 is used instead of the cordless screwdriver 28 and the bolt 11 is used instead of the screw 8.

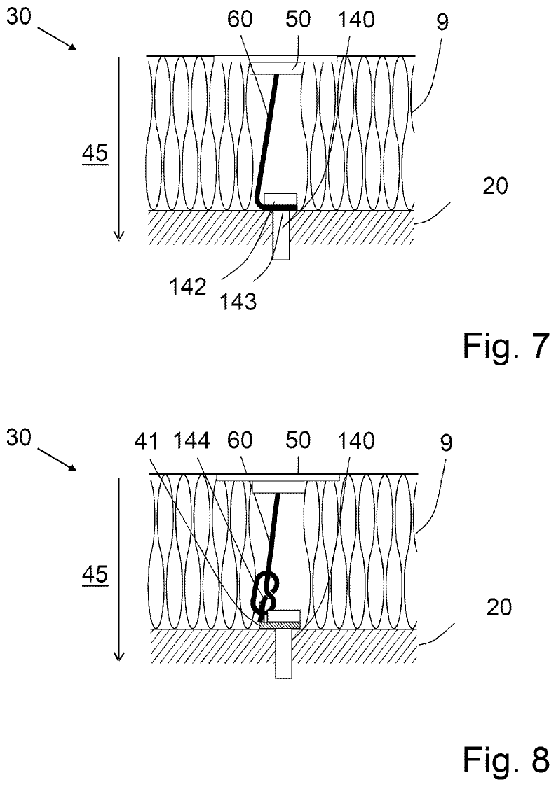

FIG. 7 shows a first object 9, a second object 20 and a fastening device 30 with an anchoring element, a prestressing element 50 and a tension element 60. The anchoring element is comprises a dowel 140, which is anchored in a hole previously produced in the second object 20, for example by means of a drilling tool, by screwing, clamping and/or expanding in a fastening device 45. The anchoring element has a head 142 and a neck 143 arranged therebelow, to which the tension element 60 is directly fastened. In contrast to the exemplary embodiment illustrated in FIG. 2, a connecting element is not provided. The other elements preferably correspond to the corresponding elements of the exemplary embodiment shown in FIG. 1.

FIG. 8 likewise shows a first object 9, a second object 20 and a fastening device 30 with an anchoring element, a prestressing element 50 and a tension element 60. The anchoring element is comprises a dowel 140, which is anchored in the second object 20, and a connecting element 41. The tension element 60 is fastened to the connecting element 41 and thus to the anchoring element 40 by means of a knot 144. The other elements preferably correspond to the corresponding elements of the exemplary embodiment shown in FIG. 1.

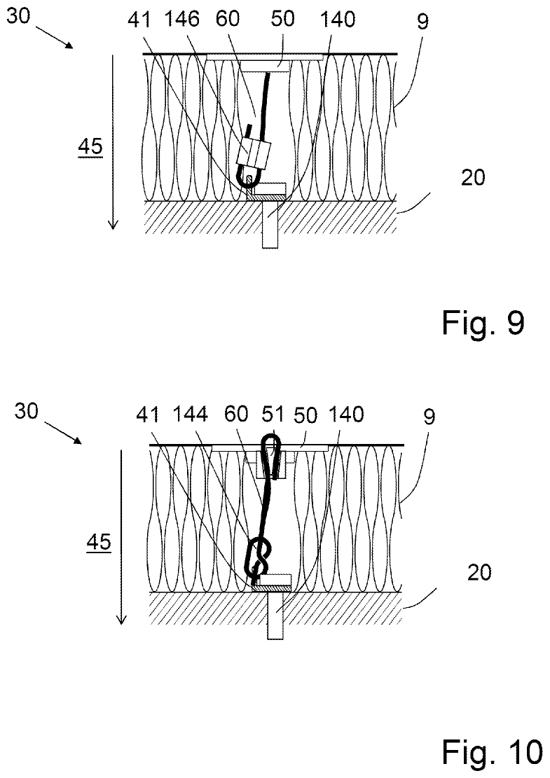

FIG. 9 likewise shows a first object 9, a second object 20 and a fastening device 30 with an anchoring element, a prestressing element 50 and a tension element 60. The anchoring element is comprises a dowel 140, which is anchored in the second object 20. The tension element 60 is fastened to the connecting element 41 and thus to the anchoring element 40 by means of a ferrule 146. The other elements preferably correspond to the corresponding elements of the exemplary embodiment shown in FIG. 1.

FIG. 10 likewise shows a first object 9, a second object 20 and a fastening device 30 with an anchoring element, a prestressing element 50 and a tension element 60. The anchoring element is comprises a dowel 140, which is anchored in the second object 20, and a connecting element 41. The tension element 60 is fastened to the connecting element 41 and thus to the anchoring element 40 by means of a knot 144 and to the prestressing element 50 by means of a clamping connection 51. The other elements preferably correspond to the corresponding elements of the exemplary embodiment shown in FIG. 1.

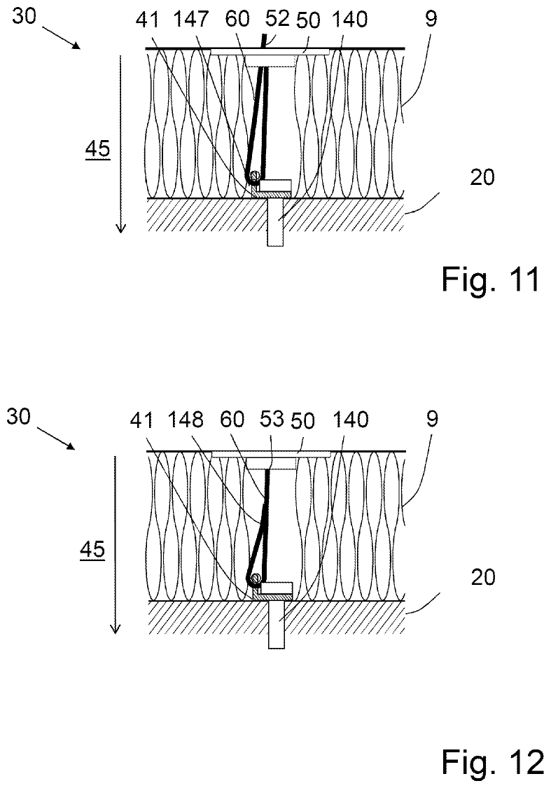

FIG. 11 likewise shows a first object 9, a second object 20 and a fastening device 30 with an anchoring element, a prestressing element 50 and a tension element 60. The anchoring element is comprises a dowel 140, which is anchored in the second object 20, and a connecting element 41. The tension element 60 is fastened by passing through an eyelet 147 to the connecting element 41 and thus to the anchoring element 40 and to the prestressing element 50 by means of a further clamping connection 52. The other elements preferably correspond to the corresponding elements of the exemplary embodiment shown in FIG. 1.

FIG. 12 likewise shows a first object 9, a second object 20 and a fastening device 30 with an anchoring element, a prestressing element 50 and a tension element 60. The anchoring element is comprises a dowel 140, which is anchored in the second object 20, and a connecting element 41. The tension element 60 is fastened to the connecting element 41 and thus to the anchoring element 40 by means of a splice connection 148 and to the prestressing element 50 by means of an adhesive connection 53. The other elements preferably correspond to the corresponding elements of the exemplary embodiment shown in FIG. 1.

The invention has been described with reference to a fastening device for an insulating element on a building cover. However, it should be noted that the invention can also be used for other purposes.

1. A device for fastening a first object to a second object in a fastening direction, the device comprising an anchoring element, a tension element and a prestressing element, wherein the anchoring element is provided to be anchored in a fastening direction in the second object, wherein the tension element is provided to transmit a tensile force from the anchoring element to the prestressing element to prestress the prestressing element in the fastening direction against the first object, and wherein the tension element comprises a composite of a plurality of fibers.

2. The device as claimed in claim 1, wherein the tension element is flexible.

3. The device as claimed in claim 2, wherein the plurality of fibers are movable relative to one another.

4. The device as claimed in claim 1, wherein the plurality of fibers each have a fiber longitudinal direction which is oriented substantially in a direction of the tensile force.

5. The device as claimed in claim 4, wherein the plurality of fibers each extend from the anchoring element to the prestressing element.

6. The device as claimed in claim 4, wherein the plurality of fibers each have a fiber length which is smaller than a distance between the anchoring element and the prestressing element.

7. The device as claimed in claim 1, wherein the tension element is fastened to the anchoring element and/or to the prestressing element.

8. The device as claimed in claim 1, wherein the anchoring element and/or the prestressing element has a head and a neck to which the tension element is fastened.

9. The device as claimed in claim 1, wherein the anchoring element and/or the prestressing element has an eyelet to which the tension element is fastened.

10. The device as claimed in claim 1, wherein the plurality of fibers are connected to form a rope, a band or to form a tube.

11. The device as claimed in claim 1, wherein the plurality of fibers are twisted together, braided or interwoven.

12. The device as claimed in claim 1, wherein the plurality of fibers comprise natural fibers.

13. The device as claimed in claim 1, wherein the plurality of fibers comprise synthetic fibers in particular made of carbon, aramid, polyester, polyamide, polypropylene, polyethylene and/or poly(p-phenylene-2,6-benzobisoxazole) (Zylon).

14. The device as claimed in claim 1, wherein the plurality of fibers comprise metal fibers in particular made of iron, steel and/or aluminum.

15. The device as claimed in claim 7, wherein the tension element is knotted, spliced, sewn, clamped, welded, brazed and/or adhesively bonded to the anchoring element and/or to the prestressing element.

16. The device as claimed in claim 12, wherein the plurality of fibers comprise natural fibers made of cotton, flax, hemp, coconut, manila, sisal and/or spider silk.

17. The device as claimed in claim 2, wherein the plurality of fibers each have a fiber longitudinal direction which is oriented substantially in a direction of the tensile force.

18. The device as claimed in claim 3, wherein the plurality of fibers each have a fiber longitudinal direction which is oriented substantially in a direction of the tensile force.

19. The device as claimed in claim 2, wherein the tension element is fastened to the anchoring element and/or to the prestressing element.

20. The device as claimed in claim 3, wherein the tension element is fastened to the anchoring element and/or to the prestressing element.
